(19) United States
(12) Patent Application Publication
(10) Pub. No.: US 2023/0203976 A1
(43) Pub. Date: Jun. 29, 2023

(54) EXHAUST SYSTEM LAYOUTS FOR DIESEL ENGINE

(71) Applicant: GM GLOBAL TECHNOLOGY OPERATIONS LLC, Detroit, MI (US)

(72) Inventors: Rahul MITAL, Rochester Hills, MI (US); Jianwen LI, West Bloomfield, MI (US); Eric Darvin Thomas, Shelby Township, MI (US)

(21) Appl. No.: 17/562,463

(22) Filed: Dec. 27, 2021

(51) Int. Cl. F01N 3/20; F01N 3/021

(52) U.S. Cl. CPC F01N 3/2066; F01N 3/021; F01N 2570/14; F01N 2570/18

(57) ABSTRACT

An exhaust system includes a selective catalytic reduction (SCR) catalyst, a diesel oxidation catalyst, and an ammonia slip catalyst. The SCR catalyst is configured to reduce nitrogen oxide in exhaust gas produced by a diesel engine. The diesel oxidation catalyst is configured to reduce particulate matter, hydrocarbon, and carbon monoxide in the exhaust gas. The diesel oxidation catalyst is disposed downstream of the first SCR catalyst. The ammonia slip catalyst is configured to reduce ammonia in the exhaust gas. The ammonia slip catalyst is disposed downstream of the first SCR catalyst and upstream of the first diesel oxidation catalyst.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to exhaust system layouts for a diesel engine.

An exhaust system for a diesel engine typically includes a diesel oxidation catalyst, a selective reduction catalytic reduction (SCR) catalyst, and a diesel particulate filter. The diesel oxidation catalyst reduces carbon monoxide, hydrocarbon, and particulate matter emissions in exhaust gas flowing therethrough. The SCR catalyst reduces nitrogen oxide emissions in exhaust gas flowing therethrough. The diesel particulate filter traps soot (PM emissions) in exhaust gas flowing therethrough and thereby removes soot from the exhaust gas.

### SUMMARY

An example of an exhaust system according to the present disclosure includes a first selective catalytic reduction (SCR) catalyst, a first diesel oxidation catalyst, and a first ammonia slip catalyst. The first SCR catalyst is configured to reduce nitrogen oxide in exhaust gas produced by a diesel engine. The first diesel oxidation catalyst is configured to reduce particulate matter, hydrocarbon, and carbon monoxide in the exhaust gas. The first diesel oxidation catalyst is disposed downstream of the first SCR catalyst. The first ammonia slip catalyst is configured to reduce ammonia in the exhaust gas. The first ammonia slip catalyst is disposed downstream of the first SCR catalyst and upstream of the first diesel oxidation catalyst.

In one aspect, the first diesel oxidation catalyst and the first ammonia slip catalyst are disposed on a single substrate.

In one aspect, the first diesel oxidation catalyst is disposed on a first substrate, and the first ammonia slip catalyst is disposed on a second substrate.

In one aspect, the exhaust system further includes a second diesel oxidation catalyst configured to reduce particulate matter, hydrocarbon, and carbon monoxide in the exhaust gas. The second diesel oxidation catalyst is disposed upstream of the first SCR catalyst.

In one aspect, the exhaust system further includes a diesel particulate filter configured to remove particulate matter from the exhaust gas. The diesel particulate filter is disposed downstream of the first diesel oxidation catalyst.

In one aspect, the exhaust system further includes a mixer configured to mix the exhaust gas. The mixer is disposed downstream of the first diesel oxidation catalyst and upstream of the diesel particulate filter.

In one aspect, the exhaust system further includes a hydrocarbon injector configured to inject diesel fuel into the exhaust gas to increase the temperature of the exhaust gas and thereby regenerate the diesel particulate filter. The hydrocarbon injector is disposed upstream of the first ammonia slip catalyst.

In one aspect, the exhaust system further includes a second SCR catalyst configured to reduce nitrogen oxide in the exhaust gas. The second SCR catalyst is disposed on a substrate within the diesel particulate filter.

In one aspect, the exhaust system further includes a second SCR catalyst configured to reduce nitrogen oxide in the exhaust gas. The second SCR catalyst is disposed downstream of the first diesel oxidation catalyst.

In one aspect, the exhaust system further includes a second ammonia slip catalyst configured to reduce ammonia in the exhaust gas. The second ammonia slip catalyst is disposed downstream of the second SCR catalyst.

In one aspect, the exhaust system further includes a first reductant injector configured to inject a first reductant into the exhaust gas at a location upstream of the first SCR catalyst. The first ammonia slip catalyst is configured to reduce ammonia that is formed from the first reductant and passes through the first SCR catalyst.

In one aspect, the exhaust system further includes a second reductant injector configured to inject a second reductant into the exhaust gas at a location upstream of the second SCR catalyst and downstream of the first diesel oxidation catalyst. The second ammonia slip catalyst is configured to reduce ammonia that is formed from the second reductant and passes through the first SCR catalyst.

Another example of an exhaust system according to the present disclosure includes a first diesel oxidation catalyst, a first SCR catalyst, a diesel particulate filter, and a first ammonia slip catalyst. The first diesel oxidation catalyst is configured to reduce particulate matter, hydrocarbon, and carbon monoxide in exhaust gas produced by a diesel engine. The first SCR catalyst is configured to reduce nitrogen oxide in the exhaust gas. The first SCR catalyst is disposed downstream of the first diesel oxidation catalyst. The diesel particulate filter is configured to remove particulate matter from the exhaust gas. The diesel particulate filter is disposed downstream of the first SCR catalyst. The first ammonia slip catalyst is configured to reduce ammonia in the exhaust gas. The first ammonia slip catalyst is disposed downstream of the first SCR catalyst and upstream of the diesel particulate filter.

In one aspect, the exhaust system further includes a second diesel oxidation catalyst configured to reduce particulate matter, hydrocarbon, and carbon monoxide in the exhaust gas. The second diesel oxidation catalyst is disposed downstream of the first ammonia slip catalyst and upstream of the diesel particulate filter.

In one aspect, the first ammonia slip catalyst and the second diesel oxidation catalyst are disposed on a single substrate.

In one aspect the first ammonia slip catalyst is disposed on a first substrate, and the second diesel oxidation catalyst is disposed on a second substrate.

In one aspect, the exhaust system further includes a second SCR catalyst configured to reduce nitrogen oxide in the exhaust gas. The second SCR catalyst is disposed on a substrate within the diesel particulate filter.

In one aspect, the exhaust system further includes a second SCR catalyst configured to reduce nitrogen oxide in the exhaust gas. The second SCR catalyst is disposed downstream of the diesel particulate filter.

In one aspect, the exhaust system further includes a second ammonia slip catalyst configured to reduce ammonia in the exhaust gas. The second ammonia slip catalyst is disposed downstream of the second SCR catalyst.

An example of a catalytic converter according to the present disclosure includes a housing, a substrate, an ammonia slip catalyst, and a diesel oxidation catalyst. The housing has an inlet port and an outlet port. The substrate is disposed within the housing. The ammonia slip catalyst is disposed on a first portion of the substrate. The ammonia slip catalyst is configured to reduce ammonia in exhaust gas produced by a diesel engine. The diesel oxidation catalyst is disposed on a second portion of the substrate that is downstream from the first portion of the substrate. The diesel oxidation catalyst is configured to reduce particulate matter, hydrocarbon, and carbon monoxide in the exhaust gas.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system including an example exhaust system according to the principles of the present disclosure;

FIG. 2 is a perspective view of an example catalytic converter according to the principles of the present disclosure; and

FIG. 3 is a functional block diagram of another example engine system including another example exhaust system according to the principles of the present disclosure.

In the drawings, reference numbers may be reused to identify similar and/or identical elements.

### DETAILED DESCRIPTION

The present disclosure describes layouts of an exhaust system for a diesel engine. The exhaust system layouts improve emissions reductions while minimizing the packaging space required for the exhaust system. In one example, the exhaust system includes a diesel oxidation catalyst and an ammonia slip catalyst integrated into a single catalytic converter and disposed on a common substrate in different zones of the catalytic converter. Integrating the ammonia slip catalyst with the diesel oxidation catalyst reduces the level of ammonia emissions released from the exhaust system without requiring a substantial amount of additional packaging space.

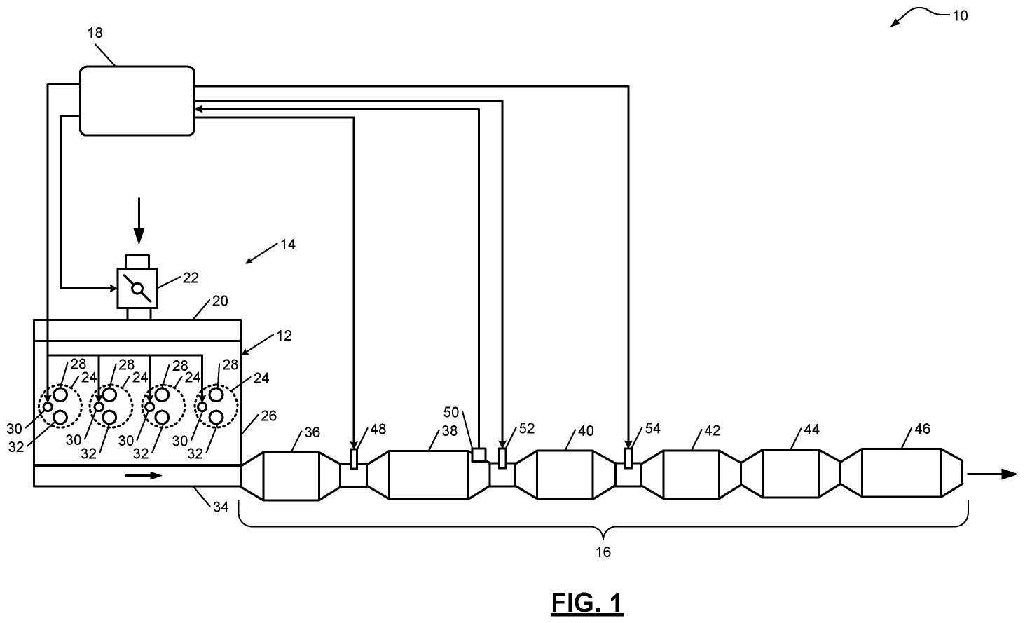

Referring now to FIG. 1, an engine system 10 includes an engine 12, an intake system 14, an exhaust system 16, and an engine control module (ECM) 18. The engine 12 combusts an air/fuel mixture to produce drive torque for a vehicle. Air is drawn into the engine 12 through the intake system 14. Air flow through the intake system 14 may be referred to as intake air flow. The intake system 14 includes an intake manifold 20 and a throttle valve 22. The throttle valve 22 may include a butterfly valve having a rotatable blade. The ECM 18 regulates opening of the throttle valve 22 to control the amount of air drawn into the intake manifold 20.

Air from the intake manifold 20 is drawn into cylinders 24 defined in an engine block 26 of the engine 12. For example only, the engine 12 is shown with four cylinders arranged in an inline configuration. However, the engine 12 may include additional or fewer of the cylinders than shown, and the cylinders may be arranged in a V configuration. For example only, the engine 12 may include 2, 3, 5, 6, 8, 10, and/or 12 cylinders arranged in various configurations such as an inline configuration or a V configuration. The ECM 18 may deactivate some of the cylinders, which may improve fuel economy under certain engine operating conditions.

The engine 12 may operate using a four-stroke cycle. The four strokes, described below, are named the intake stroke, the compression stroke, the combustion stroke, and the exhaust stroke. During each revolution of a crankshaft (not shown), two of the four strokes occur within each cylinder 24. Therefore, two crankshaft revolutions are necessary for each cylinder 24 to experience all four of the strokes.

During the intake stroke, air from the intake manifold 20 is drawn into each cylinder 24 through an intake valve 28. The ECM 18 regulates fuel delivery to each cylinder 24 by adjusting the opening duration and timing of a fuel injector 30. The fuel injector 30 may inject fuel directly into each cylinder 24 or into a mixing chamber associated with each cylinder 24, such as a mixing chamber located near the intake valve 28 of each cylinder 24. The ECM 18 may halt delivery of fuel to cylinders that are deactivated.

The injected fuel mixes with air and creates an air/fuel mixture in the cylinders 24. During the compression stroke, a piston (not shown) within each cylinder 24 compresses the air/fuel mixture. The engine 12 is a compression-ignition (e.g., diesel) engine, and therefore compression in the cylinder 24 ignites the air/fuel mixture. Combustion within each cylinder 24 may be referred to as a firing event.

During the combustion stroke, the combustion of the air/fuel mixture drives the piston down, thereby driving the crankshaft. The combustion stroke may be defined as the time between the piston reaching TDC and the time at which the piston returns to bottom dead center (BDC). During the exhaust stroke, the piston begins moving up from BDC and expels exhaust gas (containing the byproducts of combustion) through an exhaust valve 32. The exhaust gas is exhausted from the vehicle via an exhaust manifold 34 and the exhaust system 16. The exhaust manifold 34 may be considered part of the engine 12 and/or the exhaust system 16.

The exhaust system 16 includes a diesel oxidation catalyst (DOC) 36, a selective catalytic reduction (SCR) catalyst 38, an ammonia slip catalyst (ASC)/DOC 40, a mixer 42, a diesel particulate filter (DPF) 44, and a SCR catalyst/ASC 46. As their name implies, the ASC/DOC 40 includes an ASC and a DOC, and the SCR catalyst/ASC 46 includes an SCR catalyst and an ASC. Each of the DOC 36, the SCR catalyst 38, the ASC/DOC 40, and the SCR/ASC 46 may be disposed on one or more substrates contained within a catalytic converter.

The DOC 36 and the DOC of the ASC/DOC 40 reduce carbon monoxide (CO), hydrocarbon (HC), and particulate matter (PM) emissions in exhaust gas flowing therethrough. In one example, the DOC 36 and the DOC of the ASC/DOC 40 convert CO, HC, and PM to carbon dioxide (CO2) and water (H2O). The DOC 36 and the ASC/DOC 40 contain precious metals such as palladium and/or platinum.

The SCR catalyst 38 and the SCR catalyst of the SCR catalyst/ASC 46 reduce nitrogen oxide (NOx) emissions in exhaust gas flowing therethrough. In one example, the SCR catalyst 38 and the SCR catalyst of the SCR catalyst/ASC 46 use a reductant, such as diesel exhaust fluid, to convert nitrogen oxide into nitrogen (N2) and H2O. The SCR catalyst 38 and the SCR catalyst of the SCR catalyst/ASC 46 are made from oxides of base metals such as vanadium, iron, or copper zeolites. The volume of the SCR catalyst 38 may be within a range from 7.5 liters (L) to 9 L.

The ASCs of the ASC/DOC 40 and the SCR catalyst/ASC 46 reduce ammonia (NH3) emissions in exhaust gas flowing therethrough. In one example, the ASCs of the ASC/DOC 40 and the SCR catalyst/ASC 46 convert NH3 into N2 and H2O. The ASCs of the ASC/DOC 40 and the SCR catalyst/ASC 46 are made from precious metals such as palladium and/or platinum. The volume of the ASC/DOC 40 may be about 5 L, and the volume of the SCR catalyst/ASC 46 may be within a range from 5 L to 10 L.

The mixer 42 mixes exhaust gas flowing therethrough. In various implementations, the mixer 42 includes a baffle that creates turbulence in exhaust gas flow. In various implementations, exhaust gas flowing through the exhaust system 16 may be sufficiently mixed without the mixer 42, in which case the mixer 42 may be omitted. The DPF 44 traps soot (PM emissions) in exhaust gas flowing therethrough and thereby removes soot from the exhaust gas. The volume of the DPF 44 may be about 9 L. In various implementations, the level of the PM emissions released into the atmosphere by the exhaust system 16 may conform with government regulations without the presence of the DPF 44, in which case the DPF 44 may be omitted.

The exhaust system 16 further includes a reductant injector 48, a NOx sensor 50, an HC injector 52, and a reductant injector 54. While the exhaust system 16 may include additional NOx sensors, only the NOx sensor 50 is shown for illustration purposes. The reductant injectors 48, 54 inject a reductant into exhaust gas flowing through the exhaust system 16. The reductant may be anhydrous ammonia (NH3), aqueous ammonia (NH4OH), or an aqueous urea (CO(NH2)2) solution (e.g., diesel exhaust fluid). The reductant is or forms NH3, and the NH3 reacts with NOx on the SCR catalyst 38 and the SCR catalyst of the SCR catalyst/ASC 46 to produce N2 and CO2. The SCR catalyst 38 and the SCR catalyst of the SCR catalyst/ASC 46 store excess NH3 that does not react with NOx to produce N2 and CO2. The ECM 18 controls the timing and duration of reductant injections performed by the reductant injectors 48, 54.

The NOx sensor 50 measures the level of NOx in exhaust gas exiting the SCR catalyst 38 and generates a signal indicating the NOx level. The ECM 18 may assess the ability of the SCR catalyst 38 to reduce NOx based on the NOx level from the NOx sensor 50. Additionally or alternatively, the ECM 18 may adjust the timing and duration of reductant injections performed by the reductant injector 48 based on the NOx level from the NOx sensor 50.

The HC injector 52 injects diesel fuel into exhaust gas flowing through the exhaust system 16. The DOC 36 oxidizes the diesel fuel, which generates a temperature exotherm that combusts soot trapped in the DPF 44. In this way, the HC injector 52 regenerates the DPF 44. The ECM 18 controls the timing and duration of diesel fuel injections performed by the HC injector 52.

The DOC 36 and the DOC of the ASC/DOC 40 improve the performance of the SCR catalyst 38 and the SCR catalyst of the SCR catalyst/ASC 46, respectively, by oxidizing NO to produce NO2. The SCR catalyst 38 and the SCR catalyst of the SCR catalyst/ASC 46 function most efficiently when the ratio of NO to NO2 in the exhaust gas is 1 to 1. Since exhaust gas produced by the engine 12 typically contains a much greater amount of NO than NO2, the DOC 36 and the DOC of the ASC/DOC 40 adjust the ratio of NO to NO2 to a value that improves the efficiency of the SCR catalyst 38 and the SCR catalyst of the SCR catalyst/ASC 46, respectively.

The DOC of the ASC/DOC 40 oxidizes diesel fuel injected by the HC injector 52. In various implementations, the ECM 18 may control the fuel injectors 30 of the engine 12 to perform post injections to regenerate the DPF 44. In these implementations, the DOC of the ASC/DOC 40 and the HC injector 52 may be omitted.

The SCR catalyst 38 and the SCR catalyst of the SCR catalyst/ASC 46 operate most efficiently within a temperature range from 250 degree Celsius (° C.) to 450° C. Due to their distances from the engine 12, the SCR catalyst 38 is within the temperature range when the engine 12 is under low load, and the SCR catalyst of the SCR catalyst/ASC 46 is within the temperature range when the engine 12 is under high load. The various implementations, the SCR catalyst 38 may be located a certain distance from engine 12 so that SCR catalyst 38 is within the temperature range regardless of whether the engine 12 is under low or high load. In these implementations, the SCR catalyst of the SCR catalyst/ASC 46 and the reductant injector 54 may be omitted.

As discussed above, the SCR catalyst 38 and the SCR catalyst of the SCR catalyst/ASC 46 store excess NH3 that does not react with NOx to produce N2 and CO2. When the NH3 storage capacity of the SCR catalyst 38 or the SCR catalyst of the SCR catalyst/ASC 46 is reached, NH3 escapes the respective one of the SCR catalyst 38 or the SCR catalyst of the SCR catalyst/ASC 46. This phenomenon is referred to as ammonia slip. The ASC of the ASC/DOC 40 reduces ammonia that escapes the SCR catalyst 38, and the ASC of the SCR catalyst/ASC 46 reduces ammonia that escapes the SCR of the SCR catalyst/ASC 46. Thus, in implementations where the SCR catalyst of the SCR catalyst/ASC 46 is omitted, the ASC of the SCR catalyst/ASC 46 may also be omitted.

The presence of the ASC in the ASC/DOC 40 enables the ASC of the SCR catalyst/ASC 46 to be omitted if the SCR catalyst 46 is omitted. The ASC of the ASC/DOC 40 is disposed downstream of the SCR catalyst 38 so that it can reduce ammonia that escapes the SCR catalyst 38. In addition, the ASC of the ASC/DOC 40 is disposed downstream of the NOx sensor 50 so that the NOx sensor 50 may provide an accurate reading of the NOx (or NH3) level exiting the SCR catalyst 38.

As discussed above, the ASC/DOC 40 may be disposed on one or more substrates within a catalytic converter. In one example, the ASC of the ASC/DOC 40 is applied to a substrate within a first zone of a catalytic converter, and the DOC of the ASC/DOC 40 is applied to the substrate within a second zone of the catalytic converter. The second zone downstream of the first zone. Incorporating the ASC/DOC 40 on a single substrate and/or within a single catalytic converter reduces the size of the exhaust system 16 relative to other ASC/DOC configurations.

In various implementations, the ASC of the ASC/DOC 40 may be incorporated in the SCR catalyst 38 instead of the ASC/DOC 40. For example, the SCR catalyst 38 may be applied to a substrate within a first zone of a catalytic converter, and the ASC of the ASC/DOC 40 may be applied to the substrate within a second zone of the catalytic converter. The second zone downstream of the first zone. In addition, the NOx sensor 50 may extend into the catalytic converter at a location between the first and second zones of the catalytic converter.

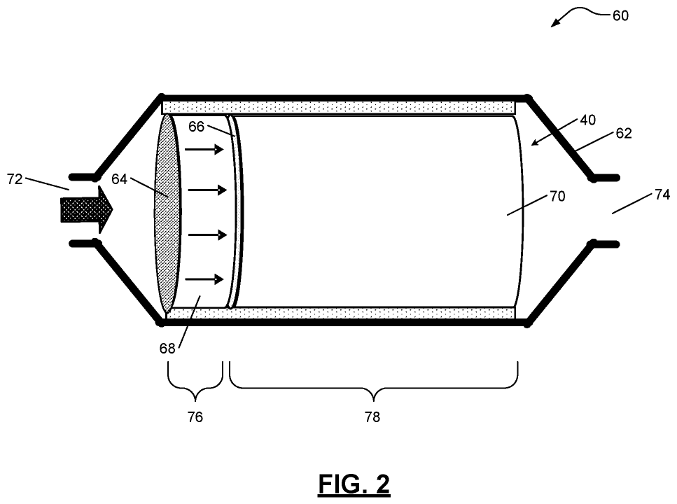

Referring now to FIG. 2, an example implementation of a catalytic converter 60 including the ASC/DOC 40 is shown. The catalytic converter 60 includes a converter housing 62, a first substrate (or substrate portion) 64, a second substrate (or substrate portion) 66, a first substrate housing (or housing portion) 68, and a second housing (or housing portion) 70. The converter housing 62 has an inlet port 72 that receives exhaust gas and an outlet port 74 that expels exhaust gas. Arrows 76 indicate the direction of exhaust gas flow through the catalytic converter 60.

The ASC of the ASC/DOC 40 is disposed on the first substrate (or substrate portion) 64, and the DOC of the ASC/DOC 40 is disposed on the second substrate (or substrate portion) 66. The first substrate (or substrate portion) 64 is disposed within the first substrate housing (or housing portion) 68 and is located within a first zone 76 of the catalytic converter 60. The second substrate (or substrate portion) 66 is disposed within the second substrate housing (or housing portion) 70 and is located within a second zone 78 of the catalytic converter 60. The second zone 78 is located downstream of the first zone 76.

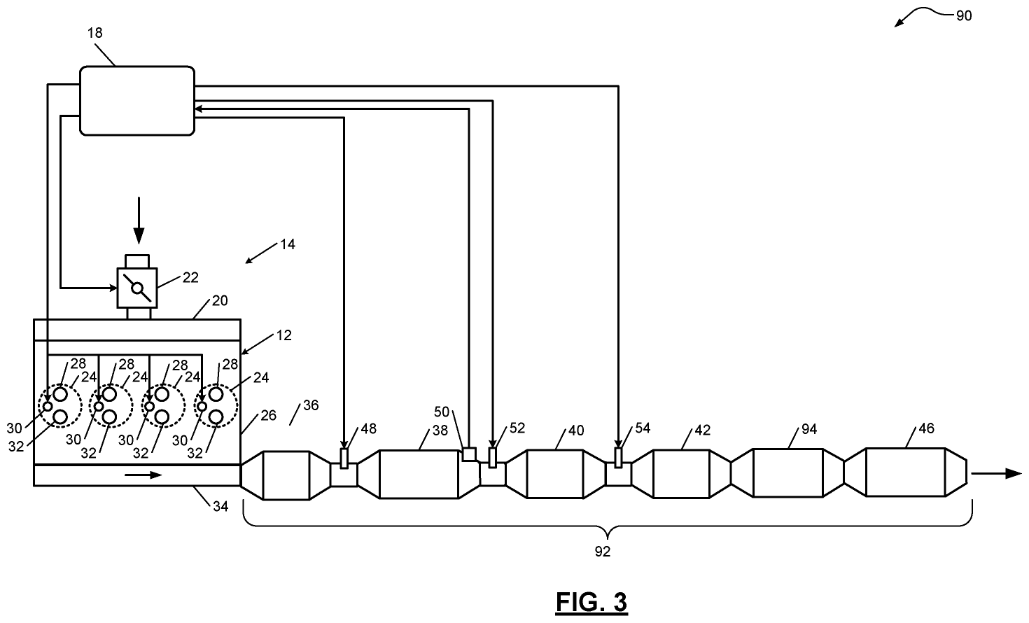

Referring now to FIG. 3, an engine system 90 and an exhaust system 92 are identical to the engine system 10 and the exhaust system 16, respectively, except that the exhaust system 92 includes a selectively catalytic reduction filter (SCRF) catalyst 94 in place of the DPF 44. The SCRF catalyst 94 includes an SCR catalyst applied to a DPF. The volume of the SCRF catalyst 94 may be about 9 L. The SCRF catalyst 94 may be included when the amount of NOx reduction provided by the SCR catalyst/ASC 46 alone is inadequate for a particular application.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. An exhaust system comprising:
a first selective catalytic reduction (SCR) catalyst configured to reduce nitrogen oxide in exhaust gas produced by a diesel engine;
a first dies& oxidation catalyst disposed on a first substrate and configured to reduce particulate matter, hydrocarbon, and carbon monoxide in the exhaust gas, wherein the first dies& oxidation catalyst is disposed downstream of the first SCR catalyst;
a first ammonia slip catalyst disposed on a second substrate and configured to reduce ammonia in the exhaust gas, wherein the first ammonia slip catalyst is disposed downstream of the first SCR catalyst and upstream of the first dies& oxidation catalyst,
wherein the first and second substrates are different substrates and are disposed within one housing, and
wherein the first ammonia slip catalyst is disposed entirely upstream of the first diesel oxidation catalyst;
a diesel particulate filter configured to remove particulate matter from the exhaust gas, wherein the diesel particulate filter is disposed downstream of the first diesel oxidation catalyst:
a mixer configured to mix the exhaust gas, wherein the mixer is disposed downstream of the first diesel oxidation catalyst and upstream of a diesel particulate filter; and
a hydrocarbon injector configured to infect dies& fuel into the exhaust gas to increase the temperature of the exhaust gas and thereby regenerate the diesel particulate filter. wherein the hydrocarbon injector is disposed upstream of the first ammonia slip catalyst. upstream of the dies& particulate filter. and upstream of the mixer.

2. (canceled)

3. (canceled)

4. The exhaust system of claim 1 further comprising a second diesel oxidation catalyst configured to reduce particulate matter, hydrocarbon, and carbon monoxide in the exhaust gas, wherein the second diesel oxidation catalyst is disposed upstream of the first SCR catalyst.

5. (canceled)

6. (canceled)

7. (canceled)

8. The exhaust system of claim 1 further comprising a second SCR catalyst configured to reduce nitrogen oxide in the exhaust gas, wherein the second SCR catalyst is disposed on a substrate within the diesel particulate filter.

9. The exhaust system of claim 1 further comprising a second SCR catalyst configured to reduce nitrogen oxide in the exhaust gas, wherein the second SCR catalyst is disposed downstream of the first dies& oxidation catalyst.

10. The exhaust system of claim 9 further comprising a second ammonia slip catalyst configured to reduce ammonia in the exhaust gas, wherein the second ammonia slip catalyst is disposed downstream of the second SCR catalyst.

11. The exhaust system of claim 10 further comprising a first reductant injector configured to inject a first reductant into the exhaust gas at a location upstream of the first SCR catalyst, wherein the first ammonia slip catalyst is configured to reduce ammonia that is formed from the first reductant and passes through the first SCR catalyst.

12. The exhaust system of claim 11 further comprising a second reductant injector configured to inject a second reductant into the exhaust gas at a location upstream of the second SCR catalyst and downstream of the first diesel oxidation catalyst, wherein the second ammonia slip catalyst is configured to reduce ammonia that is formed from the second reductant and passes through the first SCR catalyst.

13. An exhaust system comprising:
a first diesel oxidation catalyst disposed on a first substrate and configured to reduce particulate matter, hydrocarbon, and carbon monoxide in exhaust gas produced by a diesel engine;
a first SCR catalyst configured to reduce nitrogen oxide in the exhaust gas, wherein the first SCR catalyst is disposed downstream of the first diesel oxidation catalyst;
a diesel particulate filter configured to remove particulate matter from the exhaust gas, wherein the diesel particulate filter is disposed downstream of the first SCR catalyst;
a first ammonia slip catalyst disposed on a second substrate and configured to reduce ammonia in the exhaust gas, wherein the first ammonia slip catalyst is disposed downstream of the first SCR catalyst and upstream of the diesel particulate filter,
wherein the first and second substrates are different substrates and are disposed within one housing, and
wherein the first ammonia slip catalyst is disposed entirely upstream of the first diesel oxidation catalyst;
a mixer configured to mix the exhaust gas, wherein the mixer is disposed downstream of the first diesel oxidation catalyst and upstream of the diesel particulate filter; and
a hydrocarbon infector configured to infect diesel fuel into the exhaust gas to increase the temperature of the exhaust gas and thereby regenerate the diesel particulate filter. wherein the hydrocarbon injector is disposed upstream of the first ammonia slip catalyst, upstream of the dies& particulate filter, and upstream of the mixer.

14. The exhaust system of claim 13 further comprising a second diesel oxidation catalyst configured to reduce particulate matter, hydrocarbon, and carbon monoxide in the exhaust gas, wherein the second diesel oxidation catalyst is disposed upstream of the first ammonia slip catalyst and upstream of the first SCR catalyst.

15. (canceled)

16. (canceled)

17. The exhaust system of claim 13 further comprising a second SCR catalyst configured to reduce nitrogen oxide in the exhaust gas, wherein the second SCR catalyst is disposed on a substrate within the diesel particulate filter.

18. The exhaust system of claim 13 further comprising a second SCR catalyst configured to reduce nitrogen oxide in the exhaust gas, wherein the second SCR catalyst is disposed downstream of the diesel particulate filter.

19. The exhaust system of claim 18 further comprising a second ammonia slip catalyst configured to reduce ammonia in the exhaust gas, wherein the second ammonia slip catalyst is disposed downstream of the second SCR catalyst.

20. A catalytic converter system comprising;
a housing having an inlet port and an outlet port;
first and second substrates disposed within the housing, the first and second substrates being different substrate
an ammonia slip catalyst disposed on the first substrate, wherein the ammonia slip catalyst is configured to reduce ammonia in exhaust gas produced by a diesel engine; and
a diesel oxidation catalyst disposed on the second substrate that is downstream from the first substrate, wherein the diesel oxidation catalyst is configured to reduce particulate matter, hydrocarbon, and carbon monoxide in the exhaust gas,
wherein the ammonia slip catalyst is disposed entirely upstream of the diesel oxidation catalyst;
a diesel particulate filter configured to remove particulate matter from the exhaust gas, wherein the diesel particulate filter is disposed downstream of the diesel oxidation catalyst;
a mixer configured to mix the exhaust gas, wherein the mixer is disposed downstream of the diesel oxidation catalyst and upstream of the diesel particulate filter; and
a hydrocarbon injector configured to infect diesel fuel into the exhaust gas to increase the temperature of the exhaust gas and thereby regenerate the diesel particulate filter, wherein the hydrocarbon injector is disposed upstream of the ammonia slip catalyst, upstream of the dies& particulate filter, and upstream of the mixer.
